(19) United States
(12) Patent Application Publication
(10) Pub. No.: US 2012/0124558 A1
(43) Pub. Date: May 17, 2012

(54) SCENARIO TESTING COMPOSABILITY ACROSS MULTIPLE COMPONENTS

(75) Inventors: Andrew McManama Smith, Seattle, WA (US); Andhy Koesnandar, Seattle, WA (US)

(73) Assignee: MICROSOFT CORPORATION, Redmond, WA (US)

(21) Appl. No.: 12/948,700

(22) Filed: Nov. 17, 2010

(51) Int. Cl. G06F 9/44

(52) U.S. Cl. 717/125; 717/127

(57) ABSTRACT

Testing of multi-layered software using a scenario description that includes multiple action descriptions that are each interrelated in accordance with a scenario flow. Test software is run against each of at least some of the layers in the software. For each layer, an execution context is identified. Code is then identified and run for each action description and each execution context.

### BACKGROUND

Software is ever present and an enabler for many modern technologies. As technology has advanced, software has become ever more complex. Currently, applications may include multiple interacting components, which are often layered in a stack or other more intricate hierarchy. To avoid unintended consequences in such complexity, software testing is important.

In order to properly test software, the software is subjected to a variety of scenarios including some commonly anticipated scenarios, as well as potentially some border cases. If a software defect is detected during the course of running the software through a scenario, that defect may then be corrected.

In an informal testing environment, these scenarios may be manually created on the fly by the tester. However, for more controlled testing, formalized written scenario descriptions are often composed and used to guide the software through a variety of predetermined scenarios. To automate such testing, the scenario descriptions may often even be written in conformance with a schema that can be interpreted by a computing system. The computing system then uses these descriptions to guide the automated testing of the software as the software runs through the scenario defined by the description.

When testing software having multiple components or layers, when a defect is detected, it can be difficult to determine which software component or layer is causing the defect due to abstractions between components or layers. Furthermore, conventionally, different scenario descriptions are often written for each layer to account for the different functionality expected of a layer as the layer runs through its unique functionality to support the overall scenario. Furthermore, if the software or application program interface should change, the scenario descriptions often change as well to account for the changed functionality of the software and/or the different application program interface structure.

### BRIEF SUMMARY

At least one embodiment described herein relates to the testing of multi-layered software using a scenario description that includes multiple action descriptions that are each interrelated in accordance with a scenario flow. Test software is run against each of at least some of the layers in the software. For each layer, an execution context is identified. Code is then identified and run for each action description and each execution context.

Some embodiments described herein permit for the source of a particular defect to be more readily identified amongst the multiple layers of the application. Furthermore, changes in the software under test do not require redrafting of the scenario or action descriptions. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2A illustrates multi-layered software that may include any number of layers;

FIG. 2B illustrates an alternative configuration for the multi-layered software;

FIG. 3 illustrates an example scenario description;

FIG. 4 illustrates a code graph in which code is associated with an execution context 1 through 5 and an action A through D; and

FIG. 5 illustrates a flowchart of a method for a computing system to test multi-layered software in accordance with the principles described herein.

### DETAILED DESCRIPTION

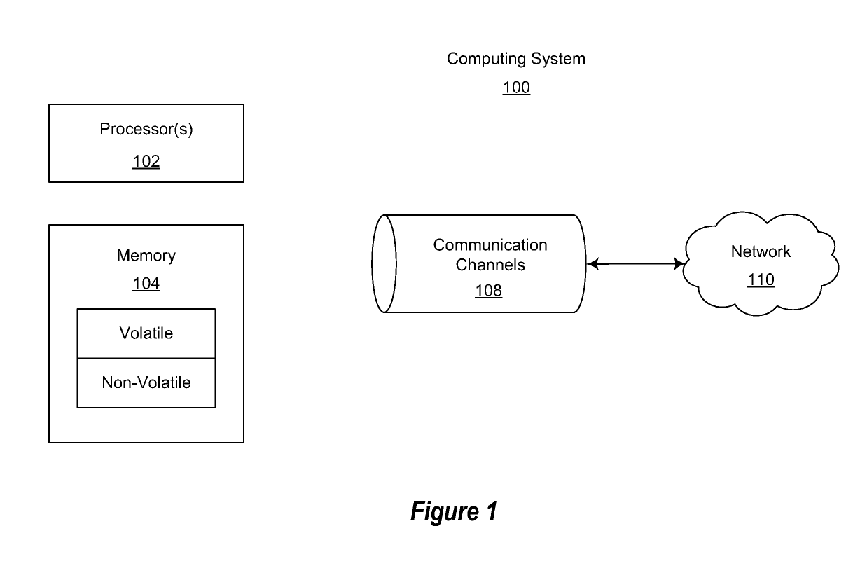

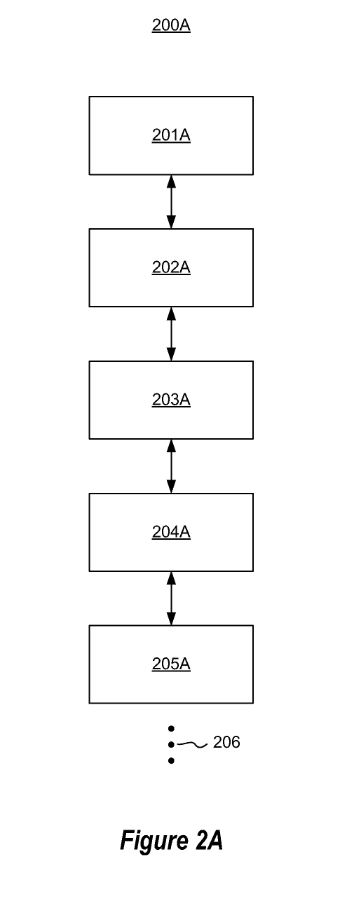

In accordance with embodiments described herein, the testing of multi-layered software is described. The testing is accomplished using a scenario description that includes multiple action descriptions that are each interrelated in accordance with a scenario flow. Test software is run against each of at least some of the layers in the software. For each layer, an execution context is identified. Code is then identified and run for each action description and each execution context. First, some introductory discussion regarding computing systems will be described with respect to FIG. 1. Then, the embodiments of the testing will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems. As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2A illustrates multi-layered software 200A. Multi-layered software may include any number of layers. The principles described herein are not limited to the structure or number of layers within the multi-layered software under test. However, for illustrative purposes only, the multi-layered software 200A is illustrates as including five layers 201A through 205A ordered vertically as a single stack. However, the ellipses 206A represent that the principles described herein may apply to the testing of any multi-layered software of any number of layers, and of any structure. For instance, multi-layered software under test may have a more hierarchically complex structure, perhaps being tree-structured, as opposed to being a simple stack.

For instance, FIG. 2B illustrates one alternative structure for multi-layered software 200B. In this case, there is a back-end server 203B that has two corresponding middle-tier servers that can call into the back-end server 203B. For instance, back-end server 203B has corresponding middle-tier servers 202B and 204B. A user-interface component 201B interfaces with the middle-tier server 202B. In addition, two additional user interface components 205B and 206B may call into the middle-tier server 204B. In this description and in the claims, each of the servers 201B, 202B, 203B, 204B, 205B and 206B may be a distinct layer or component in the system.

At least some embodiments described herein may test multi-layered software in a manner that when a defect is detected, the layer that represents the source of the defect may be discovered through perhaps automation of the testing process. More regarding this automation will be described further below.

The testing is performed using a scenario description that describes a test scenario that is to be applied to test the multi-layered software. Each scenario may include one or more actions to be performed on the multi-layered software in a certain scenario flow. The scenario description thus includes multiple action descriptions and unless implicit, perhaps some indication of the flow of the actions to be performed as part of the scenario. For instance, the scenario flow may including sequential flows in which one action is performed after the prior act is complete, parallel flows in which there may be two or more actions performed simultaneously, and/or branching flows in which actions in one path may be performed at the exclusion of one or more other paths.

There may also be a topology description that describes the topology of the multi-layered software. This topology description may be included within the scenario description, but may be a separate description as well. The topology description describes how the different components of the multi-layered software interacts, as well as the dependencies between those layers. For instance, a topology description might describe the topology of FIG. 2A, or perhaps the more complex topology of FIG. 2B. The topology description may be consulted to automatically identify which component is causing a fault.

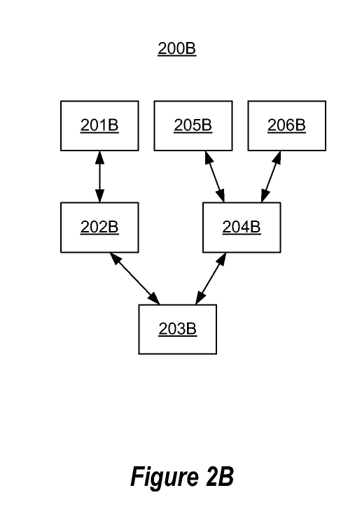

FIG. 3 illustrates an example scenario description 300. In this particular case, the scenario description includes four action descriptions 301 through 304 that are configured in a particular scenario flow, with first the action 301 being performed, and then one of two branches is performed—either a first branch in which actions 302 and 303 are performed in sequence, or a second branch in which action 304 is performed. This is just an example, however, as the principles described herein may be applied regardless of the sequence flow or the number or nature of the constituent actions. This broad application of the principles described herein is symbolically represented by the ellipses 305. Each action may correspond to a particular data contract that is enforced when the action as implemented.

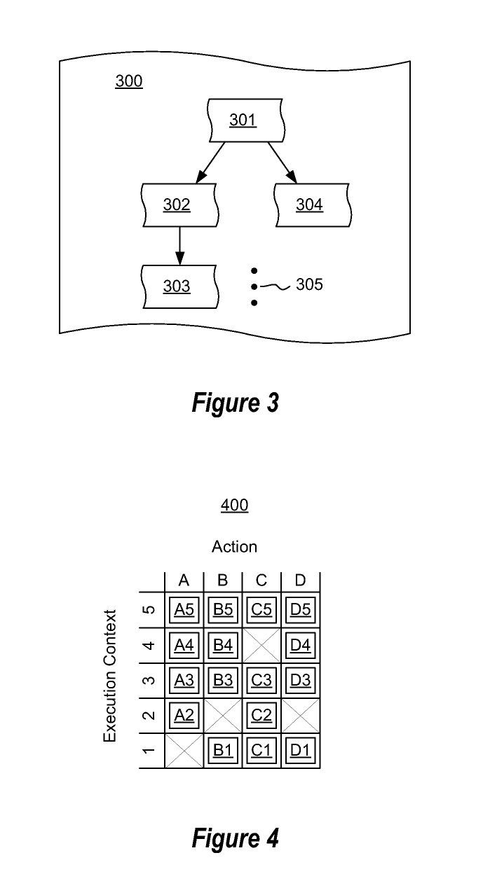

One final structure will now be described in preparation for describing the testing process itself. FIG. 4 illustrates a code graph 400 in which code is associated with an execution context 1 through 5 and an action A through D. The execution context is basically the identity of a layer or component in the multi-layered application. The action is simply an action of the scenario for that specific layer. An actual graph need not be used to perform the principles described herein. However, the graph is used as a functional illustration showing that there may is code that corresponds to a particular combination of an execution context and an action, the code being executed against the corresponding execution context when the corresponding action is to be tested on the execution context.

For example, in FIG. 4, the graph 400 shows that if action A is to be performed against execution context 5, code A5 is to be retrieved and executed against the execution context 5. If action C is to be performed against execution context 2, then code C2 is to be retrieved and executed against the execution context 2. With only a few exceptions, each execution context/action pair has corresponding code that is to be executed when the corresponding action is to be performed against the execution context. For instance, code B1, C1, and D1 are respectively retrieved and executed against execution context 1 if respective actions B, C, and D are to be performed against execution context 1. Code A2 and C2 are respectively retrieved and executed against execution context 2 if respective actions A and C are to be performed against execution context 2. Code A3, B3, C3 and D3 are respectively retrieved and executed against execution context 3 if respective actions A, B, C, and D are to be performed against execution context 3. Code A4, B4 and D4 are respectively retrieved and executed against execution context 4 if respective actions A, B and D are to be performed against execution context 4. Finally, code A5, B5, C5 and D5 are respectively retrieved and executed against execution context 5 if respective actions A, B, C, and D are to be performed against execution context 5.

There are however, four pairs that have no corresponding code, which is illustrative of the fact that not all actions may suitably performed against a particular execution context. For instance, in the specific example of FIG. 4, action A is not performed against execution context 1, actions B and D are not performed against execution context 2, and action C is not performed against execution context 4. The topology description may be consulted to determine how to handle the case in which there is no action corresponding to the execution context currently under test. In that case, for example, if the topology description indicates that execution context 4 is higher than execution context 3, the system will know to call C3 in the execution context 4 because it is aware of the chain of responsibility and dependencies implicit in the topology.

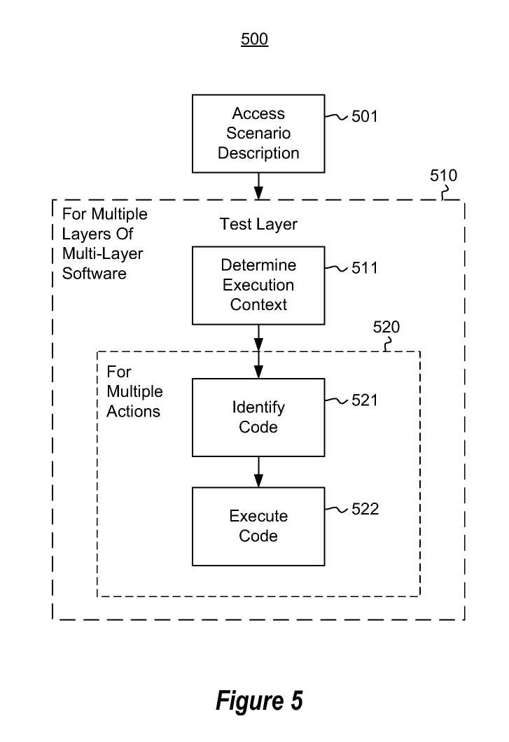

FIG. 5 illustrates a flowchart of a method 500 for a computing system to test multi-layered software. The method 500 may be performed once for each of perhaps multiple scenarios when testing the multi-layered software, thereby giving the tester a good indication of the performance of the software. The method 500 may also be performed against different kinds of multi-layered software. An example of multi-layered software was described above with respect to the multi-layered software 200 of FIG. 2.

The testing is performed at the direction of a scenario description. Accordingly, a scenario description is accessed (act 501). An example of a scenario description was described above with respect to the scenario description 300 of FIG. 3. As previously mentioned, the scenario description describes one or more actions of the scenario, and thus includes one or more action descriptions that are interrelated in accordance with a scenario flow. The scenario description may be accessed by a physical computing system by, for example, having one or more physical processors of the computing system cause an in-memory representation of the scenario description to be loaded into a physical memory of the computing system. The remaining portions of the method may also be performed by the physical computing system at the direction of the one or more physical processors.

Then, for each of multiple layers (and potentially all layers) of the multi-layered software, the layer is tested (act 510) by running testing software against the layer. First, the execution context of the particular layer is determined (act 511). Then, for each of at least some (or all) of the action descriptions associated with the scenario, the content of box 520 may be performed for each action of the scenario in the order of the scenario flow.

Specifically, code is identified corresponding to the particular action description and the execution context (act 521). For instance, referring to the graph 400 of FIG. 4, suppose that the execution context 3 is to have action B applied against it, in that case code B3 would be identified. The identified code is then accessed and run against the particular layer (act 522). For instance, code B3 may be run against the execution context 3. As part of this execution, the data contract corresponding to the action may be honored. For instance, the data contract might specify that one action is to result in a particular object that follows a particular schema, and that next action consumes that object. Furthermore, the scenario flow may specify which data is needed for later actions and how to retrieve it when needed.

In one embodiment, the scenario action is run against each layer in a systematic way, perhaps in sequence, until a source for a defect is found. Suppose that execution context 5 relies on proper operation of execution context 4 in order to function, and further that execution context 4 relies on proper operation of execution context 3 in order to function. This supposition may be learned by the system upon consultation of the topology description. In that case, suppose that there is a defect that occurs when testing action B against execution context 5. The action B may then be run against the execution context 4. If the defect is still found, the action B may be run against the execution context 3. If the defect is not found there, then the system may conclude and report that there is a defect in the execution context 4 when performing action B, and that execution context 4 is the source of the error. Identifying the source of the error helps a great deal when debugging and testing complex software, which is often multi-layered.

To further clarify the principles described herein, a particular example scenario will now be described as applied to a particular example multi-layered software. In this example, the scenario actions are performed in sequence and are as follows:

1) Create a USA customer

2) Create an order with annual subscription

3) Execute process to generate charges and invoices

4) Advance time 1 month

5) Execute a process and no invoice is generated

6) Advance time 1 year

7) Execute a process to generate invoice

Referring to action 1 (create a USA costumer), each layer of the multi-layered software will perform different tasks in order to complete the action. The code associated with each layer will direct the corresponding layer to perform their unique tasks needed to accomplish the overall action. As a further example, advancing time (as in actions 4 and 6) may involve different tasks for different layers. The corresponding accessed code is unique to each action and layer, and thus each layer will be directed to perform any needed tasks required to advance time. Thus, the scenario may be tested against the multi-layered software. Should the multi-layered software change, there might perhaps be some change to the corresponding code that performs the action against the layer that changed. However, the scenario description itself need not change.

Accordingly, the principles described herein permit for flexible use of a scenario description to test a scenario against multi-layered software, while allowing the source of a particular defect to be more readily identified. Furthermore, scenario descriptions may be shared among development groups responsible for different layers in the software to ensure each layer is tested against a consistent set of scenarios. Also, the test gap may be reduced or minimized between components, as each layer may be tested at the same time, or close to the same time. Finally, since the test case is not tied up to a specific implementation, it is easier for non-technical people to define, revise, and review the scenarios.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a computing system to test multi-layered software, the method comprising:
an act of one or more physical processors of the computing system causing a scenario description to be loaded into one or more physical memories of the computing system, the scenario description including a plurality of action descriptions that are each interrelated in accordance with a scenario flow;
for each of at least multiple layers of a plurality of layers in multi-layered software, an act of the one or more physical processors running testing software that causes the computing system to perform the following:
an act of determining an execution context associated with the particular layer; and
in accordance with the scenario flow, and for each of at least some of the action descriptions, an act of identifying code that corresponds to the particular action description and the execution context, and an act running the identified code against the particular layer.

2. The method in accordance with claim 1, wherein the scenario flow includes a sequential flow.

3. The method in accordance with claim 1, wherein the scenario flow includes a parallel flow.

4. The method in accordance with claim 1, wherein the scenario flow includes a branching flow.

5. The method in accordance with claim 1, wherein the act of identifying code that corresponds to the particular action description and the execution context, and the act running the identified code against the particular layer are both performed for each of all of the action descriptions.

6. The method in accordance with claim 1, wherein the method is performed for each of a plurality of scenario descriptions.

7. The method in accordance with claim 1, wherein the act of the one or more physical processors running the testing software is performed against all of the plurality of layers in the multi-layered software.

8. The method in accordance with claim 1, wherein the act of the one or more physical processors running the test software is performed against each of the multiple layers in sequence until a source for a defect is found.

9. The method in accordance with claim 1, further comprising:
an act of presenting test results for each of the multiple layers to a tester.

10. The method in accordance with claim 1, further comprising:
an act of identifying to a tester which of the multiple layers caused a defect.

11. A computer program product comprising one or more computer storage media having thereon computer executable instructions, that when executed by one or more processors of a computing system, cause the computing system to perform the following:
an act of accessing a scenario description that includes a plurality of action descriptions that are each interrelated in accordance with a scenario flow;
for each of at least multiple layers of a plurality of layers in multi-layered software, an act of determining an execution context associated with the particular layer; and for each of at least some of the action descriptions, performing the following:
an act of identifying code that corresponds to the particular action description and the execution context, and
an act running the identified code against the particular layer.

12. The computer program product in accordance with claim 11, wherein the scenario flow includes a sequential flow.

13. The computer program product in accordance with claim 11, wherein the scenario flow includes a parallel flow.

14. The computer program product in accordance with claim 11, wherein the scenario flow includes a branching flow.

15. The computer program product in accordance with claim 11, wherein the act of identifying code that corresponds to the particular action description and the execution context, and the act running the identified code against the particular layer are both performed for each of all of the action descriptions.

16. The computer program product in accordance with claim 11, wherein the method is performed for each of a plurality of scenario descriptions.

17. The computer program product in accordance with claim 11, wherein the computer-executable instructions are further structured such that, when executed by the one or more processors, the one or more processors are further caused to perform the following:
an act of presenting test results for each of the multiple layers to a tester.

18. The computer program product in accordance with claim 17, wherein the computer-executable instructions are further structured such that, when executed by the one or more processors, the one or more processors are further caused to perform the following:
an act of identifying to a tester which of the multiple layers caused a defect.

19. The computer program product in accordance with claim 11, wherein the computer-executable instructions are further structured such that, when executed by the one or more processors, the one or more processors are further caused to perform the following:
an act of identifying to a tester which of the multiple layers caused a defect.

20. A method for a computing system to test multi-layered software, the method comprising:
an act of one or more physical processors of the computing system accessing a scenario description that including a plurality of action descriptions that are each interrelated in accordance with a scenario flow;
for each of at least multiple layers of a plurality of layers in multi-layered software, an act of running testing software that causes the computing system to perform the following:
an act of determining an execution context associated with the particular layer; and
in accordance with the scenario flow, and for each of at least some of the action descriptions, an act of identifying code that corresponds to the particular action description and the execution context, and an act running the identified code against the particular layer, wherein the act of the one or more physical processors running the test software is performed against each of the multiple layers in sequence until a source for a defect is found; and
an act of identifying to a tester which of the multiple layers caused a defect.
